(19) United States
(12) Patent Application Publication
(10) Pub. No.: US 2022/0092994 A1
(43) Pub. Date: Mar. 24, 2022

(54) CONTROLLING A VEHICLE BASED ON DETECTED MOVEMENT OF AN OBJECT

(71) Applicant: Aurora Flight Sciences Corporation, a subsidiary of The Boeing Company, Manassas, VA (US)

(72) Inventors: Zarrin Chua, Boston, MA (US); Martin Kearney-Fischer, Boston, MA (US)

(73) Assignee: Aurora Flight Sciences Corporation, a subsidiary of The Boeing Company

(21) Appl. No.: 17/481,607

(22) Filed: Sep. 22, 2021

Related U.S. Application Data
(60) Provisional application No. 63/081,991, filed on Sep. 23, 2020.

(51) Int. Cl. G08G 5/06; B64F 1/00; G05D 1/02

(52) U.S. Cl. CPC G08G 5/065; B64D 47/08; G05D 1/0202; B64F 1/002

(57) ABSTRACT

A method of controlling a vehicle includes detecting, by an optical sensor, a movement of at least one object in a field of view of the optical sensor. The method further includes identifying, by a processor circuit, a pattern based on the movement of the at least one object. The method further includes determining, by the processor circuit based on the pattern, a vehicle command to be performed by the vehicle.

### CROSS-REFERENCE TO RELATED APPLICATIONS

This application claims the benefit of priority of U.S. Provisional Application No. 63/081,991, filed Sep. 23, 2020, which is incorporated herein by reference in its entirety.

### FIELD

Embodiments described herein relate to enhancing operational efficiency of a vehicle, and more particularly to controlling, based on detected movement of an object, a vehicle, such as an unmanned aerial vehicle in a taxiing environment.

### BACKGROUND

As unmanned vehicles, such as unmanned aerial vehicles (UAVs) become more widespread, the need for reliable communication and control has increased. For example, many conventional UAVs are controlled during taxiing operations from a ground control station (GCS), which allows a remote pilot to transmit, via radio devices, taxiing and other commands to the UAV to control movement of the UAV. However, there may be instances where communication between the GCS and UAV may be diminished or unavailable. For example, obstacles such as satellite geometry or terrain and building layout may interfere with the communication link between the GCS and UAV, and bandwidth or signal interference issues may also degrade communication performance.

### SUMMARY

According to some embodiments, a method of enhancing operational efficiency of a vehicle includes detecting, by an optical sensor, a movement of at least one object in a field of view of the optical sensor. The method further includes identifying, by a processor circuit, a pattern based on the movement of the at least one object. The method further includes determining, by the processor circuit based on the pattern, a vehicle command to be performed by the vehicle.

According to some embodiments, the optical sensor includes a forward-facing optical sensor, and the field of view is directed towards a direction of the vehicle's motion.

According to some embodiments, the movement of the at least one object includes a gesture performed by a body part of a human.

According to some embodiments, the vehicle includes an aircraft, and the vehicle command includes a taxiing command that causes an aircraft to perform a taxiing operation.

According to some embodiments, the at least one object includes an equipment being held by a human.

According to some embodiments, the equipment includes an illuminated lighting element being held by the human.

According to some embodiments, determining the vehicle command further includes correlating the pattern with a relevant command of a stored command inventory.

According to some embodiments, the method further includes determining, by the processor circuit, whether the movement of the at least one object is associated with an authorization to provide the vehicle command.

According to some embodiments, the determining whether the movement of the at least one object is associated with the authorization further includes determining whether a human associated with the movement of the object is authorized to provide the vehicle command.

According to some embodiments, the determining whether the movement of the at least one object is associated with the authorization further includes identifying, by the processor circuit, a uniform element being worn by the human that is indicative of the authorization to provide the vehicle command, wherein determining whether the human is authorized is at least partially based on the uniform element.

According to some embodiments, the determining whether the movement of the at least one object is associated with the authorization further includes identifying, by the processor circuit, a fiducial being held by the human that is indicative of the authorization to provide the vehicle command, wherein determining whether the human is authorized is at least partially based on the fiducial.

According to some embodiments, the method further includes receiving, by a receiver, a signal from a transmitter associated with the at least one object, wherein determining whether the movement of the at least one object is associated with the authorization is at least partially based on the signal.

According to some embodiments, receiving the signal further includes receiving the signal that is associated with the vehicle command from a baton held by a human, and verifying, by the processor circuit, the vehicle command at least partially based on the signal.

According to another embodiment, the method further includes causing, by the processor circuit, a component of the vehicle to execute the vehicle command.

According to some embodiments, the method further includes selectively illuminating a lighting element of the vehicle to provide a visual indication of at least one of a detection of the object, a detection of the movement, a determination of the vehicle command, or an execution of the vehicle command.

According to some embodiments, the method further includes selectively moving a movable element of the vehicle to provide a visual indication of at least one of the determination of the vehicle command or the execution of the vehicle command.

According to some embodiments, a non-transitory computer-readable storage medium for enhancing operational efficiency of a vehicle includes executable instructions. In response to execution, the executable instructions cause a system that comprises a processor circuit to perform operations including receiving sensor data from at least one optical sensor of a vehicle. The operations further include, based on an analysis of the sensor data, determining a movement of an object in a field of view of the at least one optical sensor. The operations further include, based on the movement of the object, identifying a pattern. The operations further include, based on the pattern, determining a vehicle command to be performed by the vehicle.

According to some embodiments, the movement of the object comprises a gesture by a human, wherein determining the movement of the object further includes identifying the gesture. The operations further include determining whether the human is authorized to provide the vehicle command.

According to some embodiments, a system for enhancing operational efficiency of a vehicle includes a processor circuit and a memory comprising machine-readable instructions that, when executed by the processor circuit, cause the processor circuit to perform operations. The operations include identifying, by the processor circuit, at least one gesture performed by a human based on an arm movement of the human. The operations further include determining, by the processor circuit, a vehicle command to be performed by the vehicle based on the at least one gesture. The operations further include determining, by the processor circuit, whether the human is authorized to provide the vehicle command. The operations further include, in response to determining that the human is authorized, executing the vehicle command.

According to some embodiments, the system further includes a vehicle including the processor circuit and the memory, the vehicle further including: a forward-facing optical sensor configured to detect the arm movement of the human in a field of view of the optical sensor, wherein the human is external to the vehicle.

### BRIEF DESCRIPTION OF THE DRAWINGS

FIG. 1 is an example diagram of components of a vehicle (e.g., a UAV) that detects and interprets arm gestures by a human to control the UAV, according to some embodiments.

FIG. 2 is an example diagram illustrating various software modules for executing operations by the vehicle of FIG. 1, according to some embodiments.

FIG. 3A is an example flowchart diagram of operations for detecting movements of an object and determining vehicle commands based on the movements, according to some embodiments.

FIG. 3B is an example flowchart diagram of additional operations for determining whether a human associated with the movements is authorized to provide vehicle commands, according to some embodiments.

FIG. 3C is an example flowchart diagram of additional operations for operating the vehicle based on determined vehicle commands, according to some embodiments.

FIG. 4 is an example diagram illustrating detecting, by the vehicle, different arm gestures associated with different vehicle commands, according to some embodiments.

### DETAILED DESCRIPTION

The following detailed description of examples refers to the accompanying drawings, which illustrate specific examples of the disclosure. Other examples having different structures and operations do not depart from the scope of the subject disclosure. Like reference numerals may refer to the same element or component in the different drawings.

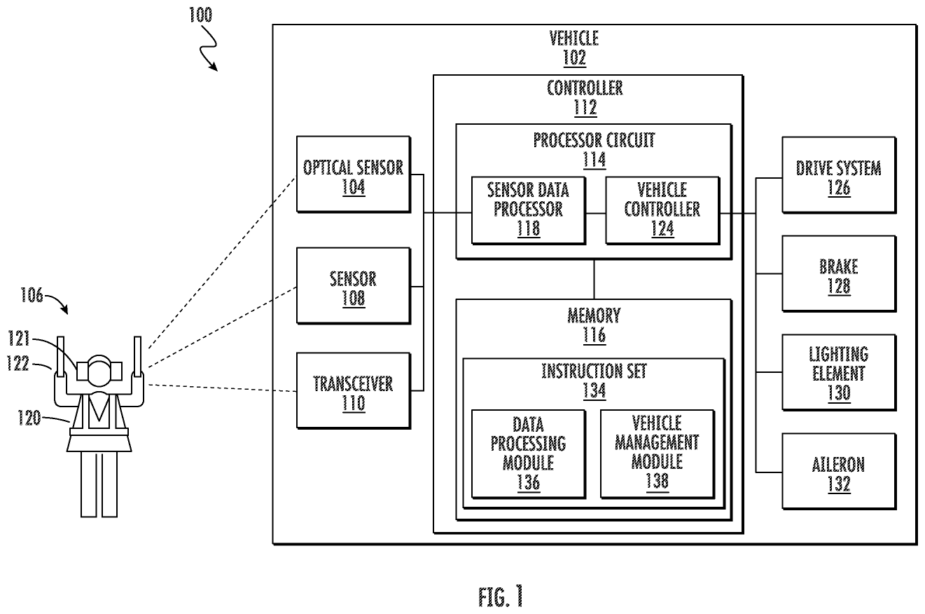

FIG. 1 is an example diagram of components of a system 100 for a vehicle 102 that detects and interprets arm gestures by a human to facilitate control of the vehicle 102, according to some embodiments. As an example, the vehicle 102 can comprise manned or unmanned vehicles, including, but not limited to unmanned aerial vehicles (UAVs). The system 100 in this example includes a vehicle 102 having a forward-facing optical sensor 104, e.g., an electro-optical camera, or another type of sensor configured to detect a movement of an object, such as an arm movement of a human 106 or movement of equipment held or worn by the human 106 for example, in a field of view of the optical sensor 104. It should also be understood that one or more optical sensors 104 or other types of sensors can be mounted in other locations on the vehicle 102 to detect other humans (e.g., wingwalkers, maintenance crew, etc.) at different locations with respect to the vehicle 102. In this example, the human 106 is a ground crew member, such as an Air Marshal, authorized to provide vehicle commands, that is external to the vehicle 102 during taxiing or other operation of the vehicle 102. In this example, the vehicle 102 can include additional devices for perceiving and/or communicating with external objects or devices, such as additional sensors 108, transceivers 110, and/or other components.

The vehicle 102 in this example includes a controller 112 having a processor circuit 114 and a memory 116 coupled to the processor circuit 114. The processor circuit 114 includes a sensor data processor 118 and a vehicle controller 124 in this example. The sensor data processor 118 receives a signal from the optical sensor 104 and identifies a gesture performed by the human 106 based on an arm movement of the human 106. The vehicle controller 124, also referred to as a mission management system, determines a vehicle command to be performed by the vehicle 102 based on the gesture and executes the vehicle command. As an example, information indicative of a vehicle command or a sequence of vehicle commands corresponding to a gesture can be stored in a data store (e.g., in memory 116 onboard vehicle 102 or a remotely coupled memory). Examples of vehicle commands include operating a drive system 126 of the vehicle 102 to move and/or steer the vehicle 102 during taxiing operations, operating a brake system 128 of the vehicle 102 to slow or stop the vehicle 102.

The sensor data processor 118 in some examples can also determine whether the human 106 is authorized to provide the vehicle command, such as by detecting an equipment being held by the human 106, such as, but not limited to, a uniform element 120 (e.g., safety vest, a pattern/logo/badge on the vest, etc.) or wearable gear, for example, ear protection 121 being worn on the body of the human 106 or a baton 122 being held by a hand of the human 106. Because many of these visual elements are specific to the aerospace industry, e.g., in the airport, helipad, or vertiport setting, the system 100 can quickly and accurately determine whether a human is authorized. Additionally, or alternatively, a defined security code or other signal can be transmitted from batons or other equipment that are equipped and/or retrofitted with additional hardware, as described in greater detail below.

The vehicle controller 124 in some examples can also provide a visual indication of detecting the human, determining the vehicle command, and/or executing the vehicle command. Examples of providing a visual indication include selectively illuminating a lighting element 130 or selectively moving a movable element, such as a control surface 132 (e.g., aileron). Such visual indication is visible to the human 106 providing the command, as a way of confirming to the human 106 that the command has been detected, recognized and/or executed. In some examples, the system 100 stores an indication that the human 106 is authorized, and accepts subsequent recognized commands from that human 106 without the need to repeat the initial authorization. In some examples, the system can provide a visual or other indication of other determinations, such as that a command has not been recognized, that the human 106 has not been identified, that the human 106 is not authorized, etc.

The memory 116 in this example is a non-transitory computer-readable storage medium that includes an instruction set 134 having executable instructions that, when executed, cause the system 100 to perform various operations. The instruction set 134 in this example includes a data processing module 136 and a vehicle management module 138.

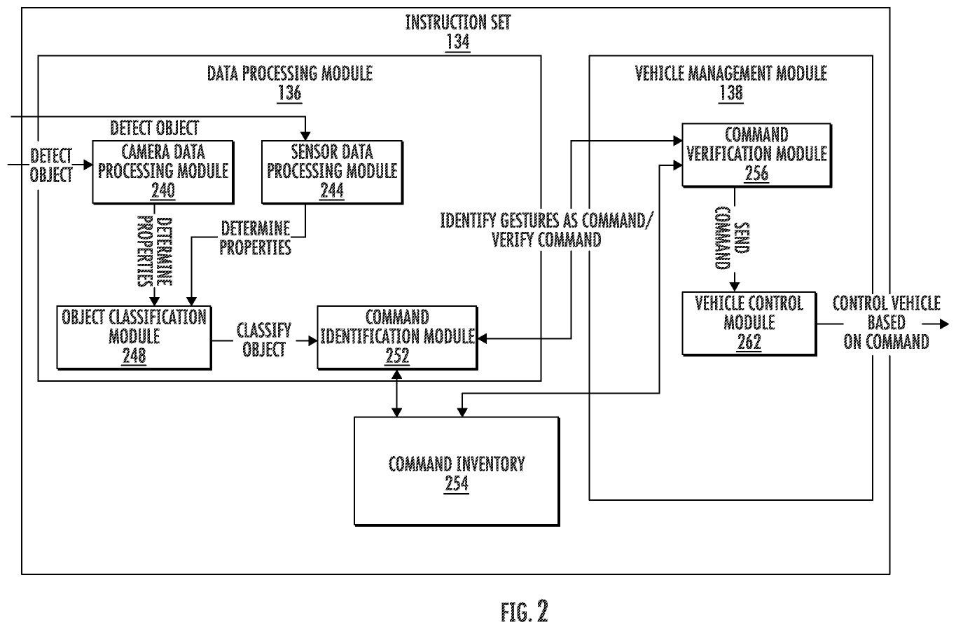

Referring now to FIG. 2, an example diagram illustrates various software modules of the instruction set 134 for executing operations by the vehicle 102 of FIG. 1, according to some embodiments. In this example, the data processing module includes a camera data processing module 240 that causes the processor circuit 114 to determine properties of objects and/or movements detected by the optical sensor 104. The data processing module 136 also includes a sensor data processing module 244 that causes the processor circuit to determine properties of objects and/or movements detected by other sensors 108. An object classification module 248 causes the processor circuit 114 to classify the objects and/or movements based on their determined properties, and a command identification module 252 identifies the gestures as specific commands. In this example, the command identification module 252 accesses a command inventory 254 stored in the memory to determine the appropriate command and provides the command to the vehicle management module 138.

In this example, a command verification module 256 of the vehicle management module 138 receives an indication of the command from the command identification module 252 and verifies the command, for example by determining whether the command is being provided by an authorized person, and upon verification sends the command to a vehicle control module 262, which causes the processor circuit 114 to perform an operation or a sequence of operations, such as, operations that control the vehicle 102 based on the command.

Embodiments herein provide unique technical solutions to a number of technical problems. For example, conventional UAVs must interact with humans using a dedicated GCS in order to receive commands, and are not capable of accepting commands or otherwise directly communicating with other humans in their environment, such as air traffic controllers, ground handlers, maintenance personnel, or other humans outside of a dedicated GCS. In addition, GCS performance may be degraded or unavailable based on ground conditions, such as satellite geometry or terrain and building layout, high utilization of limited bandwidth, inability to provide live external-facing video feeds over existing channels, or other limitations (e.g., precision of control), which may result in reduced situational awareness for a GCS operator. By allowing UAVs 102 to recognize and directly interact with humans separately from the GCS, many of these drawbacks are mitigated or eliminated. In some examples, system 100 can be employed to command the UAV when access to the UAV's GCS is not available. Embodiments also employ some hardware that is already widely used in UAVs to provide low Size, Weight and Power (SWaP) and costs. Some embodiments leverage onboard hardware, such as optical sensors 104 (e.g., electro-optical cameras) and computing components, as well as additional sensors 108 such as infrared (IR) cameras, Light Detection and Ranging (LIDAR) sensors, or other sensors. For example, many existing UAVs already include front-facing electro-optical cameras having a field of view of approximately 60 degrees. In addition, system 100 reduces or avoids the need to use a towing vehicle to move the UAV around on the ground.

In some examples, existing Air Marshal batons 122 are retrofitted with sensor hardware, e.g., a processor, an accelerometer, that is capable of detecting the movement of the baton(s) and transmitting a signal, e.g., via a Radio-Frequency (RF) transceiver, to the transceiver 110 in the vehicle 102 that is indicative of the movement. In some examples, the batons 122 are further configured to determine a gesture and/or command associated with the movement and transmit a signal to the vehicle 102 that is indicative of the command. In some examples, these features are used to verify the determination by the vehicle 102 of the relevant command, such as to provide an additional layer of security and/or reliability. In other examples, these features are capable of controlling the vehicle 102 directly, with or without a separate determination of the gesture and/or command by the vehicle 102. In some examples, the signal includes an RF code that is received by neighboring batons 122, e.g., mated batons within an arm span of each other, to calculate relative position when determining the movement and/or command.

In this example, the optical sensors 104 and/or other sensors 108 sample the environment at different frequencies. Data processing is used to improve a signal-to-noise ratio in order to detect objects in the camera's and/or sensors' field of view and range. The output includes an indication that an object is present, its relative location, its size, and other attributes, such as color, etc.

In some examples, the object classification module 248 can use algorithms such as Region-based Convolutional Neural Networks, Semantic/Instance Segmentation, Skeletal Tracking, Body Pose Estimation, etc. to determine object classifications, such as air vehicles, land vehicles, humans, obstacles, etc. based on size, color, and other factors. In some examples, the algorithm is pretrained to identify an Air Marshal 106 based on held equipment, which are distinctive and readily identifiable, such as worn orange or lime safety vests or other uniform elements 120, ear protection 121, orange batons 122, etc. The distinctiveness of these elements also improves the identification of predefined arm orientations and movements. Other software modules, such as the command identification module 252 and/or the command verification module 254, etc. can use algorithms to correlate objects, orientations, movements, etc. with appropriate identifications, authorizations, commands etc., for example by accessing the command inventory 254, applying context-based rules, using artificial intelligence, or using other algorithms to make appropriate determinations for facilitating control of the vehicle 102.

It should also be understood that these and other features can be applied to other vehicle systems, such as autonomous cars, autonomous underwater vehicles, etc. For example, autonomous cars have similar problems with interacting with humans that do not have direct access to their controls. For example, an autonomous car in some examples is configured to receive commands from police manually directing traffic, rental car agents, parking attendants, and other persons that can provide gesture-based commands to direct operation of the autonomous car.

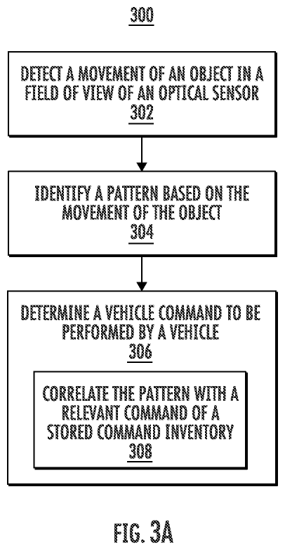

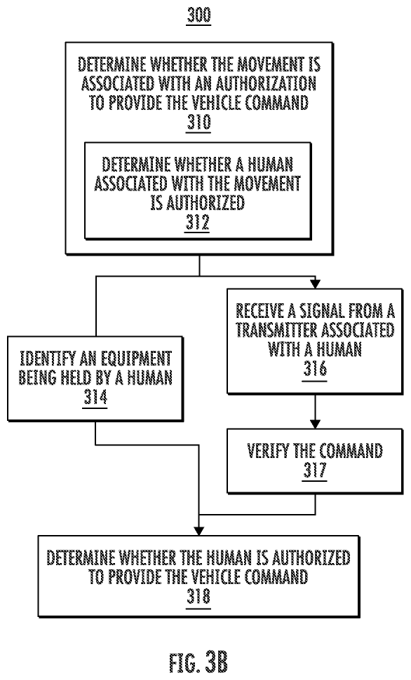

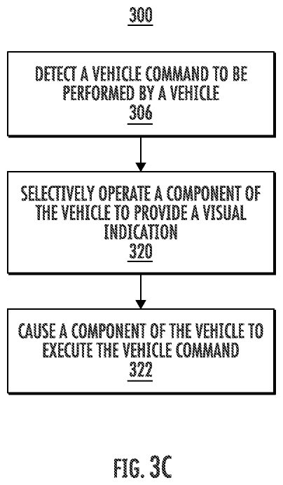

FIG. 3A is a flowchart diagram of operations 300 for detecting movements of an object and determining vehicle commands based on the movements, according to some embodiments. In this example, the operations 300 includes detecting a movement of an object in a field of view of an optical sensor (Block 302), such as by detecting an arm or other body part movement of a human that is external to a vehicle (e.g., by a forward-facing camera of a UAV), or by detecting a movement of an object (e.g., an illuminated lighting object) being held by a human, for example. Detecting the movement of the object may include detecting the object in the field of view and/or identifying the object as an object of interest (e.g., a human or a baton) within proximity of the aircraft before, during, or after detecting the movement itself. The operations 300 further include identifying a pattern based on the movement of the object (Block 304), such as by identifying a gesture of the human based on the arm movement, or identifying a motion pattern of a baton, for example. The operations 300 further include determining a vehicle command to be performed by the vehicle based on the pattern (Block 306). The determining in this example includes correlating the pattern with a relevant command of a stored command inventory (Block 308).

FIG. 3B is an example flowchart diagram of additional operations 300 for determining whether a human associated with the movements is authorized to provide vehicle commands, according to some embodiments. In this example, the operations 300 include determining whether the movement is associated with an authorization to provide the vehicle command (Block 310). In this example, the determining includes determining whether a human associated with the movement of the object is authorized to provide the specific vehicle command (Block 312). Determining whether the human is authorized to provide one or more vehicle commands can be performed before or after detecting the movement of the object (Block 302), identifying the pattern (Block 304), and/or determining the specific command (Block 306) of FIG. 3A, as desired.

The operations 300 of FIG. 3B further include identifying an equipment being held by a human (Block 314), such as identifying a fiducial being held by a hand of the human or identifying a uniform element or ear protection being worn by the human, or example. In this example, the operations 300 further include receiving a signal from a transmitter associated with a human (Block 316), such as from a baton held by a human, and verifying the vehicle command based at least in part on the signal (Block 317). Based on identifying the object and receiving the signal from the transmitter, the operations 300 further include determining whether the human is authorized to provide the command (Block 318).

FIG. 3C is a flowchart diagram of additional operations 300 for operating the vehicle based on determined vehicle commands, according to some embodiments. In this example, the operations further include selectively operating a component of the vehicle to provide a visual indication of the determination of the vehicle command or the execution of the vehicle command (Block 320), such as by illuminating a lighting element or by selectively moving a movable element of the vehicle such as an aileron to provide the visual indication. It should be understood that other types of indications, such as audio, haptic, or other indications that can be detected by an observer or system monitoring the vehicle may also be provided, as desired. The operations further include causing a component of the vehicle to execute the vehicle command (Block 322), such as operating a drive system, operating a braking system, etc., as discussed above.

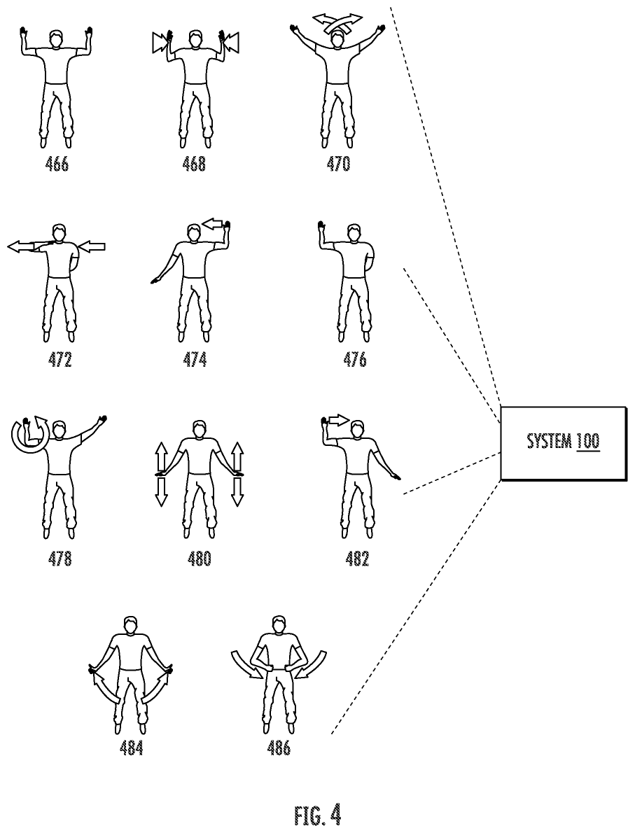

FIG. 4 is a diagram illustrating detecting, by the vehicle 102, different arm gestures associated with different vehicle commands, according to some embodiments. In this example, the gestures and command correspond to a standard lexicon of Air Marshal arm signals, which are detailed in Federal Aviation Administration's Airplane Flying Handbook (“www.faa.gov/regulations_policies/handbooks_manuals/aviation/airplane_handbook/media/04_afh_ch2.pdf”), but it should be understood that different gestures and commands can also be used. For example, gestures and/or commands can be specific for an airline or an airport and can be codified in the UAV's mission planning.

Table 1 below includes commands illustrated in FIG. 4:

TABLE 1

| | Gesture | Command |
|---|---|---|
| 466 | Arms Raised | Stop |
| 468 | Arms Raised, hands moving forward and back | Come Ahead |
| 470 | Arms moving overhead, side to side | Emergency Stop |
| 472 | Right arm moving left to right | Cut Engines |
| 474 | Right arm raised | All Clear/O.K. |
| 476 | Right arm lowered, left hand raised moving left to right | Left Turn |
| 478 | Left arm raised, right arm raised moving in circle | Start Engine |
| 480 | Arms lowered, moving up and down | Slow Down |
| 482 | Left arm lowered, right hand raised moving left to right | Right Turn |
| 484 | Arms lowered, hands moving upward and out | Pull Chocks |
| 486 | Arms lowered, hands moving downward and in | Insert Chocks |

It should also be understood that different vehicles can be used to execute different commands. For example, some UAVs do not have the capability to insert or remove chocks from the UAV's landing gear. In some examples, a maintenance vehicle or robot includes a system having the same or similar components as system 100, and is configured to execute commands associated with taxiing or other operations, such as pulling or removing chocks for example.

Further, the disclosure includes examples according to the following clauses:

Clause 1. A method of enhancing operational efficiency of a vehicle, the method comprising:
detecting, by an optical sensor, a movement of at least one object in a field of view of the optical sensor;
identifying, by a processor circuit, a pattern based on the movement of the at least one object; and
determining, by the processor circuit based on the pattern, a vehicle command to be performed by the vehicle.

Clause 2. The method of clause 1, wherein the optical sensor comprises a forward-facing optical sensor, and

wherein the field of view is directed towards a direction of the vehicle's motion.

Clause 3. The method of clause 1, wherein the movement of the at least one object comprises a gesture performed by a body part of a human.

Clause 4. The method of clause 1, wherein the vehicle comprises an aircraft, and

wherein the vehicle command comprises a taxiing command that causes an aircraft to perform a taxiing operation.

Clause 5. The method of clause 1, wherein the at least one object comprises an equipment being held by a human.

Clause 6. The method of clause 4, wherein the equipment comprises an illuminated lighting element being held by the human.

Clause 7. The method of clause 1, wherein determining the vehicle command further comprises correlating the pattern with a relevant command of a stored command inventory.

Clause 8. The method of clause 1, further comprising determining, by the processor circuit, whether the movement of the at least one object is associated with an authorization to provide the vehicle command.

Clause 9. The method of clause 8, wherein the determining whether the movement of the at least one object is associated with the authorization further comprises determining whether a human associated with the movement of the object is authorized to provide the vehicle command.

Clause 10. The method of clause 9, wherein the determining whether the movement of the at least one object is associated with the authorization further comprises identifying, by the processor circuit, a uniform element being worn by the human that is indicative of the authorization to provide the vehicle command, wherein determining whether the human is authorized is at least partially based on the uniform element.

Clause 11. The method of clause 9, wherein the determining whether the movement of the at least one object is associated with the authorization further comprises identifying, by the processor circuit, a fiducial being held by the human that is indicative of the authorization to provide the vehicle command, wherein determining whether the human is authorized is at least partially based on the fiducial.

Clause 12. The method of clause 8, further comprising receiving, by a receiver, a signal from a transmitter associated with the at least one object, wherein determining whether the movement of the at least one object is associated with the authorization is at least partially based on the signal.

Clause 13. The method of clause 12, wherein receiving the signal further comprises receiving the signal that is associated with the vehicle command from a baton held by a human; and

verifying, by the processor circuit, the vehicle command at least partially based on the signal.

Clause 14. The method of clause 1, further comprising causing, by the processor circuit, a component of the vehicle to execute the vehicle command.

Clause 15. The method of clause 14, further comprising selectively illuminating a lighting element of the vehicle to provide a visual indication of at least one of a detection of the object, a detection of the movement, a determination of the vehicle command, or an execution of the vehicle command.

Clause 16. The method of clause 14, further comprising selectively moving a movable element of the vehicle to provide a visual indication of at least one of the determination of the vehicle command or the execution of the vehicle command.

Clause 17. A non-transitory computer-readable storage medium for enhancing operational efficiency of a vehicle comprising executable instructions that, in response to execution, cause a system that comprises a processor circuit to perform operations comprising:
receiving sensor data from at least one optical sensor of a vehicle;
based on an analysis of the sensor data, determining a movement of an object in a field of view of the at least one optical sensor;
based on the movement of the object, identifying a pattern; and
based on the pattern, determining a vehicle command to be performed by the vehicle.

Clause 18. The non-transitory computer-readable storage medium of clause 17, wherein the movement of the object comprises a gesture by a human,
wherein determining the movement of the object further comprises identifying the gesture, and
wherein the operations further comprise determining whether the human is authorized to provide the vehicle command.

Clause 19. A system for enhancing operational efficiency of a vehicle comprising:
a processor circuit; and
a memory comprising machine-readable instructions that, when executed by the processor circuit, cause the processor circuit to perform operations comprising:
   identifying, by the processor circuit, at least one gesture performed by a human based on an arm movement of the human;
   determining, by the processor circuit, a vehicle command to be performed by the vehicle based on the at least one gesture;
   determining, by the processor circuit, whether the human is authorized to provide the vehicle command; and
   in response to determining that the human is authorized, executing the vehicle command.

Clause 20. The system of clause 19, further comprising: a vehicle comprising the processor circuit and the memory, the vehicle further comprising: a forward-facing optical sensor configured to detect the arm movement of the human in a field of view of the optical sensor, wherein the human is external to the vehicle.

As will be appreciated by one skilled in the art, aspects of the subject disclosure can be illustrated and described herein in any of a number of patentable classes or context including any new and useful process, machine, manufacture, or composition of matter, or any new and useful improvement thereof. Accordingly, aspects of the subject disclosure can may be implemented entirely hardware, entirely software (including firmware, resident software, micro-code, etc.) or combining software and hardware implementation that can all generally be referred to herein as a “circuit,” “module,” “component,” or “system.” Furthermore, aspects of the subject disclosure can take the form of a computer program product embodied in one or more computer readable media having computer readable program code embodied thereon.

Any combination of one or more computer readable media may be utilized. The computer readable media can be a computer readable signal medium or a computer readable storage medium. A computer readable storage medium can be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (e.g., erasable programmable read-only memory (EPROM) or Flash memory), an appropriate optical fiber with a repeater, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable signal medium can be transmitted using any appropriate medium, including but not limited to wireless, wireline, optical fiber cable, RF, etc., or any suitable combination of the foregoing.

Computer program code for carrying out operations for aspects of the subject disclosure can be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP Hypertext Preprocessor (PHP), Advanced Business Application Programming (ABAP), dynamic programming languages such as Python, Ruby and Groovy, or other programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the subject disclosure are described herein with reference to flowchart illustrations or block diagrams of methods, apparatuses (systems) and computer program products according to embodiments of the disclosure. It will be understood that each block of the flowchart illustrations or block diagrams, and combinations of blocks in the flowchart illustrations or block diagrams, can be implemented by machine-readable instructions, e.g., computer program instructions. These machine-readable instructions can be provided to a processor of a general-purpose computer, special purpose computer, or other programmable data processing apparatus to produce a machine, such that the instructions, which execute via the processor of the computer or other programmable instruction execution apparatus, create a mechanism for implementing the functions or acts specified in the flowchart or block diagram block or blocks.

These machine-readable instructions can also be stored in a transitory or non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function or act specified in the flowchart or block diagram block or blocks. The machine-readable instructions can also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions or acts specified in the flowchart or block diagram block or blocks. The flowchart and block diagrams in the figures illustrate the architecture, functionality, and operation of possible implementations of systems, methods, and computer program products according to various aspects of the subject disclosure. In this regard, each block in the flowchart or block diagrams can represent a module, segment, or portion of code, which includes one or more executable instructions for implementing the specified logical function(s). It should also be noted that, in some alternative implementations, the functions noted in the block may occur out of the order noted in the figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “includes,” “including,” “contains,” “containing,” “comprises” and “comprising,” and the like, when used in this specification, specify the presence of stated features, steps, operations, elements, or components, but do not preclude the presence or addition of one or more other features, steps, operations, elements, components, or groups thereof. As used herein, the term “and/or” includes any and all combinations of one or more of the associated listed items and can be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

1. A method of enhancing operational efficiency of a vehicle, the method comprising:
detecting, by an optical sensor, a movement of at least one object in a field of view of the optical sensor;
identifying, by a processor circuit, a pattern based on the movement of the at least one object; and
determining, by the processor circuit based on the pattern, a vehicle command to be performed by the vehicle.

2. The method of claim 1, wherein the optical sensor comprises a forward-facing optical sensor, and
wherein the field of view is directed towards a direction of the vehicle's motion.

3. The method of claim 1, wherein the movement of the at least one object comprises a gesture performed by a body part of a human.

4. The method of claim 1, wherein the vehicle comprises an aircraft, and
wherein the vehicle command comprises a taxiing command that causes the aircraft to perform a taxiing operation.

5. The method of claim 1, wherein the at least one object comprises an equipment being held by a human.

6. The method of claim 5, wherein the equipment comprises an illuminated lighting element being held by the human.

7. The method of claim 1, wherein determining the vehicle command further comprises correlating the pattern with a relevant command of a stored command inventory.

8. The method of claim 1, further comprising determining, by the processor circuit, whether the movement of the at least one object is associated with an authorization to provide the vehicle command.

9. The method of claim 8, wherein the determining whether the movement of the at least one object is associated with the authorization further comprises determining whether a human associated with the movement of the object is authorized to provide the vehicle command.

10. The method of claim 9, wherein the determining whether the movement of the at least one object is associated with the authorization further comprises identifying, by the processor circuit, a uniform element being worn by the human that is indicative of the authorization to provide the vehicle command, wherein determining whether the human is authorized is at least partially based on the uniform element.

11. The method of claim 9, wherein the determining whether the movement of the at least one object is associated with the authorization further comprises identifying, by the processor circuit, a fiducial being held by the human that is indicative of the authorization to provide the vehicle command, wherein determining whether the human is authorized is at least partially based on the fiducial.

12. The method of claim 8, further comprising receiving, by a receiver, a signal from a transmitter associated with the at least one object,
wherein determining whether the movement of the at least one object is associated with the authorization is at least partially based on the signal.

13. The method of claim 12, wherein receiving the signal further comprises receiving the signal that is associated with the vehicle command from a baton held by a human; and
verifying, by the processor circuit, the vehicle command at least partially based on the signal.

14. The method of claim 1, further comprising causing, by the processor circuit, a component of the vehicle to execute the vehicle command.

15. The method of claim 14, further comprising selectively illuminating a lighting element of the vehicle to provide a visual indication of at least one of a detection of the object, a detection of the movement, a determination of the vehicle command, or an execution of the vehicle command.

16. The method of claim 14, further comprising selectively moving a movable element of the vehicle to provide a visual indication of at least one of a detection of the object, a detection of the movement, a determination of the vehicle command, or the execution of the vehicle command.

17. A non-transitory computer-readable storage medium for enhancing operational efficiency of a vehicle comprising executable instructions that, in response to execution, cause a system that comprises a processor circuit to perform operations comprising:
receiving sensor data from at least one optical sensor of a vehicle;
based on an analysis of the sensor data, determining a movement of an object in a field of view of the at least one optical sensor;
based on the movement of the object, identifying a pattern; and
based on the pattern, determining a vehicle command to be performed by the vehicle.

18. The non-transitory computer-readable storage medium of claim 17, wherein the movement of the object comprises a gesture by a human,
wherein determining the movement of the object further comprises identifying the gesture, and
wherein the operations further comprise determining whether the human is authorized to provide the vehicle command.

19. A system for enhancing operational efficiency of a vehicle comprising:
a processor circuit; and
a memory comprising machine-readable instructions that, when executed by the processor circuit, cause the processor circuit to perform operations comprising:
identifying, by the processor circuit, at least one gesture performed by a human based on an arm movement of the human;
determining, by the processor circuit, a vehicle command to be performed by the vehicle based on the at least one gesture;
determining, by the processor circuit, whether the human is authorized to provide the vehicle command; and
in response to determining that the human is authorized, executing the vehicle command.

20. The system of claim 19, further comprising:
a vehicle comprising the processor circuit and the memory, the vehicle further comprising:
a forward-facing optical sensor configured to detect the arm movement of the human in a field of view of the forward-facing optical sensor, wherein the human is external to the vehicle.
